(19) United States
(12) Patent Application Publication
(10) Pub. No.: US 2019/0372621 A1
(43) Pub. Date: Dec. 5, 2019

(54) STRUCTURE FOR PREVENTING BUS SIGNAL FROM BEING AFFECTED BY LOAD CONDITION OF DEVICE DURING CIRCUIT SIGNAL TRANSMISSION

(71) Applicant: Lite Puter Enterprise Co., Ltd., New Taipei City (TW)

(72) Inventor: KUN-PAI HSU, TAIPEI CITY (TW)

(21) Appl. No.: 16/430,453

(22) Filed: Jun. 4, 2019

(30) Foreign Application Priority Data
Jun. 4, 2018 (CN) 201820853763.4

(51) Int. Cl. H04B 3/56; H04B 3/06

(52) U.S. Cl. CPC H04B 3/56; H04B 3/06

(57) ABSTRACT

A structure for preventing bus signals from being affected by conditions of a device load during circuit signal transmission includes a filter, a signal channel, a power channel, a CPU, and a power source. The filter separates power and signals and forms the signal channel and the power channel. The signal channel provides an access for a control signal to enter and exit, and the power channel provides power for a power supply and a load controlling output of a device. The power channel blocks the control signal, and the signal channel blocks power so as to prevent the control signal of a power line from being attenuated due to an overload occurred in the device.

### CROSS-REFERENCE TO RELATED PATENT APPLICATION

This application claims the benefit of priority to China Patent Application No. 201820853763.4, filed on Jun. 4, 2018 in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of communication technology, and more particularly to a structure for preventing bus signals from being affected by load conditions of a device during circuit signal transmission.

### BACKGROUND OF THE DISCLOSURE

With the rapid development of power line communication (PLC) technology, more and more smart buildings and urban management adopt power line carrier communication technology. However, PLC technology has drawbacks. For example, during signal transmission, load conditions of the device may greatly influence signal transmission. The larger the load of the device is, the greater the attenuation of power line communication signal is.

### SUMMARY OF THE DISCLOSURE

In response to the above-referenced technical inadequacies, the present disclosure provides a structure for preventing bus signals from being affected by load conditions of a device during circuit signal transmission.

In one aspect, the present disclosure provides a structure for preventing bus signals from being affected by load conditions of a device during circuit signal transmission including a filter, a signal channel, a power channel, a CPU, and a power source. The filter separates power and signals and forms the signal channel and the power channel. The signal channel provides an access for a control signal to enter and exit, and the power channel provides power for a power supply and a load controlling output of a device. The power channel blocks the control signal, and the signal channel blocks power so as to prevent the control signal of a power line from being attenuated due to an overload occurred in the device.

Based on the abovementioned design, in the present disclosure, since the filter is disposed at the initial of an input end of the device, when the device is connected to a circuit, the filter immediately separates signals from power. Even if the load conditions of the entire circuit change frequently, signals will not be interfered.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a structure according to the present disclosure.

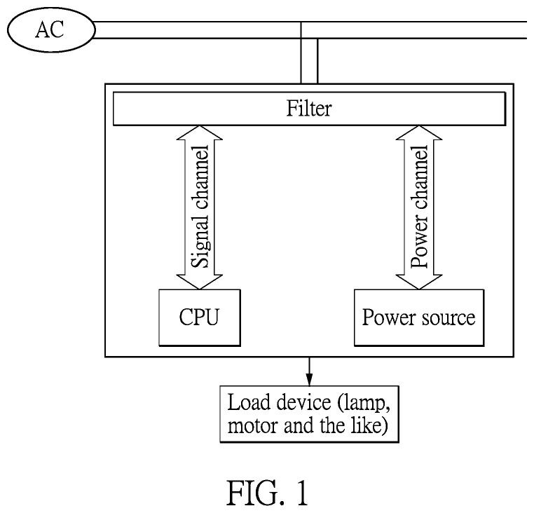

### DETAILED DESCRIPTION OF THE EXEMPLARY EMBODIMENTS

The present disclosure is more particularly described in the following examples that are intended as illustrative only since numerous modifications and variations therein will be apparent to those skilled in the art.

Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A structure for preventing bus signals from being affected by load conditions of a device during circuit signal transmission includes a filter, a signal channel, a power channel, a CPU, and a power source. The filter separates power and signals and forms the signal channel and the power channel. The signal channel provides an access for a control signal to enter and exit, and the power channel provides power for a power supply and a load controlling output of a device. The power channel blocks the control signal, and the signal channel blocks power so as to prevent the control signal of a power line from being attenuated due to an overload occurred in the device.

Based on the abovementioned design, in the present disclosure, since the filter is disposed at the initial of an input end of the device, when the device is connected to a circuit, the filter immediately separates signals from power. Even if the load conditions of the entire circuit change frequently, signals will not be interfered.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A structure for preventing bus signals from being affected by load conditions of a device during circuit signal transmission, comprising: a filter, a signal channel, a power channel, a CPU, and a power source,
wherein the filter separates power and signals and forms the signal channel and the power channel, the signal channel provides an access for a control signal to enter and exit, and the power channel provides power for a power supply and a load controlling output of a device, wherein the power channel blocks the control signal, and the signal channel blocks power so as to prevent the control signal of a power line from being attenuated due to an overload occurred in the device.
